(19) United States
(12) Patent Application Publication
(10) Pub. No.: US 2011/0210091 A1
(43) Pub. Date: Sep. 1, 2011

(54) CRANE STRUCTURE

(76) Inventor: Øyvind Bjørshol, Averoy (NO)

(21) Appl. No.: 13/060,659

(22) PCT Filed: Aug. 25, 2009
(86) PCT No.: PCT/NO09/00299

§ 371 Date: May 23, 2011

(30) Foreign Application Priority Data
Aug. 25, 2008 (NO) 20083654

(51) Int. Cl. B66C 23/10

(52) U.S. Cl. 212/232

(57) ABSTRACT

A crane characterized in that it comprises a lower vertical boom (10) and an upper horizontal boom (12), mutually connected through a joint element (20), in that the lowest part of the vertical boom is connected through a pedestal (14), the pedestal further comprising a slew ring for rotating of the crane about a vertical axis (16), and a tension rod (22) is arranged between the pedestal and the joint element in a distance from the vertical boom and mainly parallel to this in a normal position of the crane.

The present invention relates to an arrangement for a crane as indicated in the preamble of the following claim 1.

There is a disadvantage in existing crane structures with fixed boom, bending boom and telescopic boom in that the load is raised or lowered in response to radial movements. In order to move the crane boom horizontally, i.e. when a load is to be positioned horizontally, several movements must be combined, or adjustment must be made by hoisting or slackening at the winch.

As concerns the prior art, reference will be made to what is known from DE 3,602,912, U.S. Pat. No. 3,884,359, Dutch publication NL-7410091 and GB patent 2,065,597.

The patent first mentioned discloses a lifting arrangement comprising a lower boom and an upper boom, which are connected with each other by way of an articulated piece. The lower boom is arranged pivoting in a swivel head for rotation of the cranes about a vertical axis. Hydraulic cylinders are used for control of the respective booms. A tension member is mounted between the articulated piece and the upper end of a swivel head element.

### Objects of the Invention

It is an object of the invention to provide a crane construction which employs substantial movement from smallest to largest radius, outwardly from a central point.

It is an object of the invention to provide a crane construction enabling an approximately horizontal movement of the load over a complete working region, wherein vertical movement of the load is achieved with help of a winch.

It is therefore an object of the invention to provide a construction operating so that when the assembly of a vertical boom and a stay member is pivoted about a horizontal axis, a wire pulley at the end of the horizontal boom of the crane moves mainly along a straight line.

### The Invention

The crane structure of the invention is characterized by the features appearing in the following independent patent claim 1. Preferred embodiments are defined in the independent claims.

The crane structure is characterized in that it comprises a lower vertical boom 10 and an upper horizontal boom 12, which are mutually connected via an articulated member 20. The vertical boom 10 is at its bottom connected to a “crown” 14, which in turn comprises a swivel head for use in rotating the crane about a vertical axis 16, and a stay member 22 is arranged between the “crown” and the articulated member 20 at some distance from the vertical boom 10 and substantially parallel with the latter in a normal position (vertical) of the crane.

Preferably, the stay member 22 is mounted on the “crown” at another level of height relative to the vertical boom 10.

Preferably, the “crown” as seen in a side section, forms an approximately triangular design, in that a line L between the vertical boom (10) and the articulated member 20 (points A and C) mutually form an angle in a range of 30° to 60°, namely of about 45°.

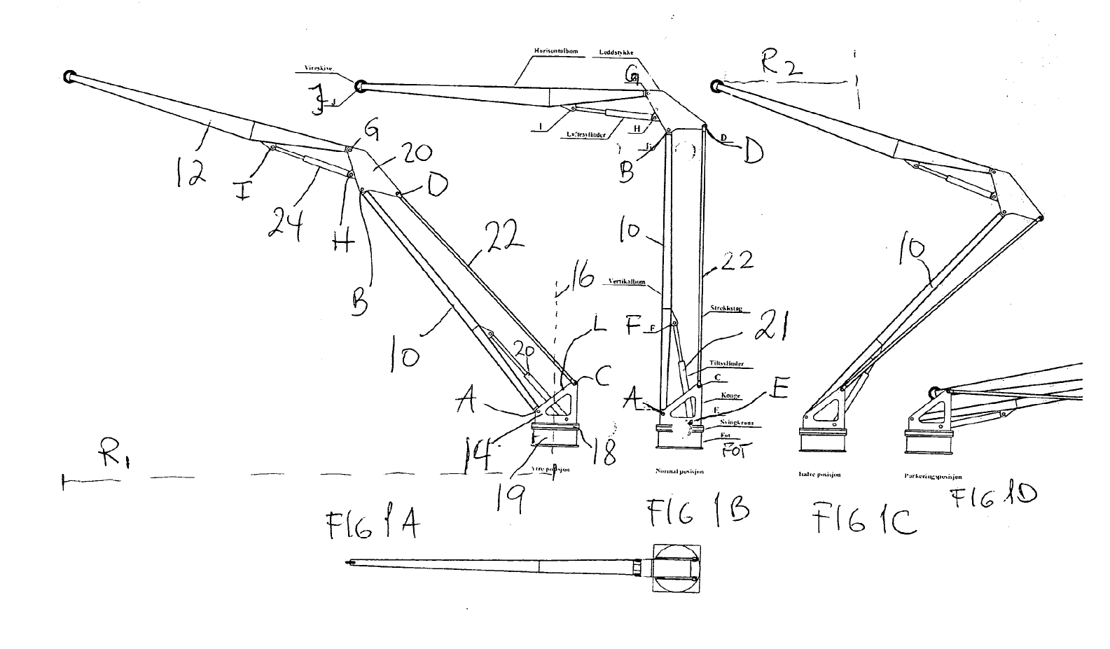

Preferably the articulated member 20 is a triangular structure, in which (in the normal position of the crane, FIG. 1B) the vertical boom 10 and the stay member 22 respectively, are attached swivelingly and spaced apart at substantially the same level of height.

Preferably the vertical boom 10, the horizontal boom 12 and the stay member 22 respectively are supported at respective corners B-D-G in the articulated member.

Preferably the stay member 22 is shorter than the vertical boom 10.

Compared to the state of art as represented by the aforementioned German patent DE-3.602.912, the following differences are pointed out in respect of the present invention.

According to the German patent, the wire runs over a curved pulley, whereas in the present invention a stay member 22 is used and connected to a point in an articulated element.

According to the German patent DE-3.602.912, the wire operates with a constant working radius, (the distance from a wire 9 to an axis 6, according to the figure), whilst the stay member 22 will have a variable working radius (the distance from the stay member 22 to point B in the aforementioned solution, see the figure which is discussed later).

In the forward and rear positions of the crane, this radius will be smaller, and will be largest in its intermediate position. The reduction of the working radius results in the horizontal boom 12 being lifted to an extra degree, and in this manner compensates for the difference in height that arise during the pivot movement.

In the German patent DE-3.602.912, the pulley disc 7 and the loading arm 8 are disposed in a common axis 6 on the top of the outer assembly 3 (see the figure in the German patent). In the present construction the boom 12 is coupled to an axis G on the articulated member 20 and therefore does not have a common axis with the articulated member 20 which rotates about the axis B on the top of the vertical boom 10.

It will be appreciated from the figures as discussed in the following that the anchoring points between the crown, the vertical boom 10, the articulated member 20 and the stay member 22 forms a rectangle with corners A, B, C, D. The decisive feature for the crane to be able to maintain a constant height for the wire pulley J, relates to the geometry of this quadrangle. First and most the position that arises between positions A and C on the crown, and especially the angle they form in relation to the horizontal plane.

Secondly it relates to the relationship between the length of the vertical boom (A-B), the length of the stay elements (C-D), the distance (B-D) of the stay element and the distance (A-C) on the crown.

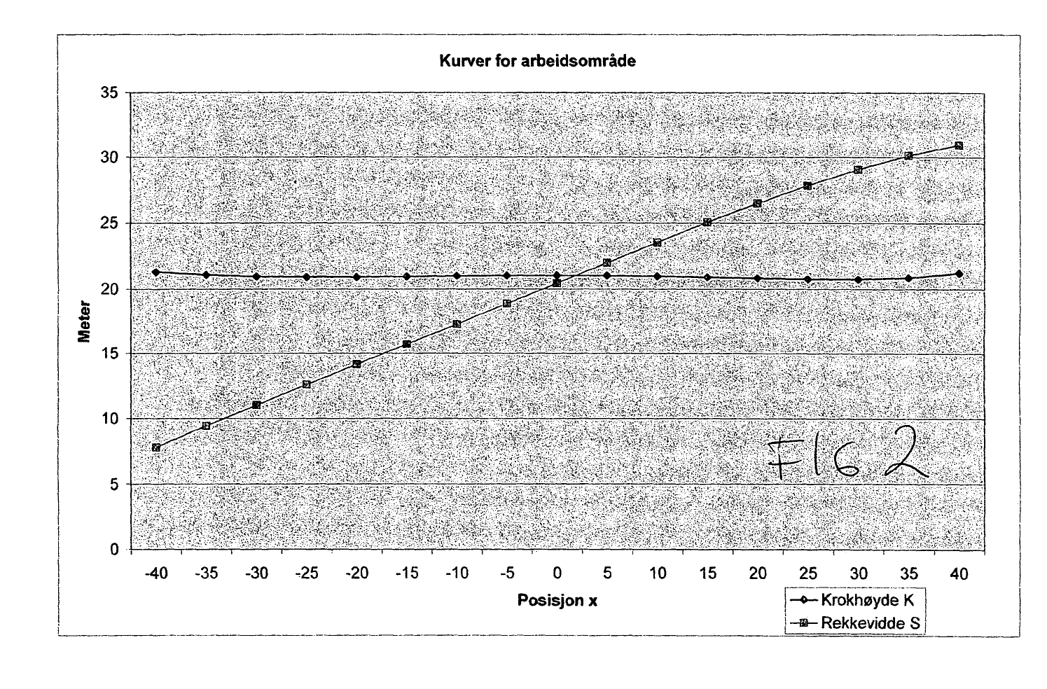

By adapting this geometry in a correct manner as described above and shown in the drawing figure, it is possible to achieve a result that the wire pulley J moves in a direct line (+/−2%) during the pivot actuation, for example pursuant to the curve shown in FIG. 2. It is also possible to define whether the lifting height is to rise or fall with increasing working radius, namely defining a slope of the straight line.

### PRACTICAL PREFERRED EMBODIMENTS

The figures will now be referred to which show various cross-sections of a crane construction pursuant to the present invention, and which when implemented, will meet the objects as elucidated above, namely that the apex J of the crane will maintain itself at substantially the same horizontal level over the entire operating range of the crane.

FIGS. 1A, 1B and 1C are illustrations of the crane pursuant to the invention in three positions, namely in its outer position (1A), in its normal position (1B) and in its inner position (1C). There is also indicated a parking position wherein the booms are mutually folded together towards each other.

FIG. 2 is an illustration of the height level of the horizontal boom (at the wire pulley J) in relation to the range of reach of the crane.

The figures provide the crane which is formed of two main parts, namely a vertical boom 10 and a horizontal boom 12. The vertical boom 10 is at its lower end coupled to a “crown” or socket component 14 which is operable to be turned about a vertical axis 16 on a bearing 18 at the top of the bottom socket 19. The vertical boom 10 is moveable with help of a tilting cylinder (alternatively in two pieces) 21 which are mounted between the point B on the crown 14 and the point F on the vertical boom 10. In the upper end of the vertical boom 10, there is disposed an articulated member 20 at the point E. The articulated member 20 can be, seen from a side view, a triangular construction. The horizontal boom 12 is coupled at the point G at a distance from the point E.

The articulated member 20 is held up and guided by way of a stay member 22 which is coupled at its lower end to the “crown” 14 at the point C, and to a lower end of the articulated member 20 at the point D. The figure provides an illustration of the “crown” 14 which has a triangular form, with horizontal and vertical leg, in that the skewed hypotenuse defines a line between points A and C on the crown, respectively. This hypotenuse subtends an angle of 45° with the horizontal. The stay member 22 is attached to the crown 14 in a point C which is at a higher horizontal level than the position whereat the horizontal boom 10 is attached to the crown 14 at the point A, which in consequence of the crown 14 defining the aforementioned angle 45°. As seen in the vertical boom 10 position as shown in FIG. 1B, the distance between the points A-C on the crown 14 is larger than the distance between the points B-D, and that the stay element 22 is somewhat shorter than the vertical boom 10. In this position, the stay element 22 and the vertical boom 10 are operable to be parallel.

The crane can rotate with help of the turning crown 18 on the foot 19 as is conventional.

The horizontal boom 12 is held up by assistance of a lifting cylinder 24 mounted between the point H on the articulated member 20 and the point I on the horizontal boom 12. At a distal end of the horizontal boom 12, there is attached a wire pulley J. This pulley guides a wire from the winch mounted onto or remote from the crane itself.

According to a simpler embodiment of the invention, the lifting cylinder 24 can be omitted. The horizontal boom 12 and the articulated member 20 form a interconnected boom. Regulation of the height of the wire pulley J as described in the following paragraph is not possible, although the load can be lifted and lowered using the winch.

In a situation that the tilting cylinder and the lifting cylinder have sufficient operating length, the crane can be folded together in a more compact position as illustrated in FIG. 1D.

### Manner of Operation

The crane moves itself between a largest radius R1 and a smallest radius R2 (reaching distance) by way of the vertical boom 10 moving forwards and backwards in relation to the vertical starting position, by way of assistance from the tilting cylinder 21. During such movement, the vertical boom 10 has as a main function to regulate the working radius of the crane. The horizontal boom 12 is operable to compensate for the height difference which arises (at point B) under this movement, such that the block (point J) is held at constant height. This occurs without the lifting cylinder being actuated, and in consequence the horizontal boom 12 follows movement of the articulated member 20. The stay member 22 steers this movement. By calculating optimal disposition of the points A, B, C and D, a compensation of movement is achieved which results in a substantially constant (horizontal) height for the wire pulley at point J. It is possible to achieve a height variation of approximately +/−2% of the radial movement.

By disposing the lifting cylinder 24 in another position, the height of the wire pulley J can be changed to approach a higher or lower position, simultaneously with it being possible to move the lifting moment closer to the centre of rotation of the crane.

This construction provides a series of advantages:
1: the boom cannot fall down. For a fall to occur, there must be a physical break in the steel construction of the crane. Loss of hydraulic power does not have any significance. In an event that the hydraulic cylinder is removed, the crane can continue to be moved horizontally.
2: the radial movement of the load is horizontal. This means that there is minimal force required for this horizontal movement, namely something which requires lower energy utilization as a consequence of employing a crane constructed pursuant to the present invention. Faster speed of operation is thereby possible in a similar manner to when the crane pivots around. This means that the load can be moved at high speed in all directions in a horizontal plane by way of rotation and radius adjustment.
3: adjustment of crane movement in operation becomes simpler and more logical. Every movement is controlled by its corresponding hydraulic function: rotation (adjustment of angle), reaching range (adjustment of radius), lifting (change in working height) and winch (raising and lowering of loads). The functions do not influence one another.

FIG. 2 is an illustration of how hook height (y-axis) in the horizontal boom 12 (at the wire pulley J) changes itself in relation to the crane's radial reaching distance or position (x-axis). As a result, the point J (wire pulley) holds itself stable at a height level of 21 to 22 metres over a given foundation level. As provided in the figures, the apex of the crane at point J is capable of a reaching range 40 metres to each side of the vertical axis 16. The position x=0 on the x-axis corresponds to the tip of the boom J intersecting the axis 16 (FIG. 1B).

1. A structure for a crane, characterized in that it comprises a lower vertical boom (10) and an upper horizontal boom (12), which are mutually connected by an articulated member (20), wherein the vertical boom (10) at the bottom is connected with a “crown” (14), which in turn comprises a swivel head for rotation of the crane about a vertical axis (16), and a stay member (22) is arranged between the “crown” and the articulated member (20) at some distance from the vertical boom (10) and substantially parallel with the latter in a normal position of the crane.

2. A structure according to claim 1, characterized in that the stay member (22) is mounted on the “crown” at another level of height than the vertical boom (10), preferably at a point C at a higher horizontal level than that of the vertical boom (10).

3. A structure according to claim 1, characterized in that in side section the “crown” forms an approximately triangular design, a line L between the connections of the vertical boom (10) and the stay member (20) (points A and C) forming an angle of about 45°.

4. A structure according to claim 1, characterized in that the articulated member (20) is a triangular structure, where (in the normal position of the crane) the support of the vertical boom (10) and that of the stay member (22) in the articulated piece are attached swiveling spaced apart at substantially the same level of height.

4. A structure according to claim 1, characterized in that the vertical boom (10), the horizontal boom (12) and the stay member (22) respectively are supported at respective corners in the articulated member (20).

5. A structure according to claim 1, characterized in that the stay member (22) is shorter than the vertical boom (10).
